(19) United States
(12) Patent Application Publication
(10) Pub. No.: US 2019/0350167 A1
(43) Pub. Date: Nov. 21, 2019

(54) DRINKING APPARATUS, A METHOD FOR OPERATING THE SAME AND A USE THEREOF

(71) Applicants: Dominic GRÉGOIRE, L'Orignal (CA); Louis GRÉGOIRE, Gatineau (CA)

(72) Inventors: Dominic GRÉGOIRE, L'Orignal (CA); Louis GRÉGOIRE, Gatineau (CA)

(21) Appl. No.: 16/415,948

(22) Filed: May 17, 2019

Related U.S. Application Data
(60) Provisional application No. 62/673,379, filed on May 18, 2018.

(51) Int. Cl. A01K 7/00; B67C 11/02

(52) U.S. Cl. CPC A01K 7/00; B67C 11/02

(57) ABSTRACT

A method and drinking apparatus provide fresh water to a living entity confined into a restricted environment, includes a first element having opposite ends. A second element defines a capacity provided with first and second openings. The first opening is at an upper part of the second element. The first and second elements are secured at opposite ends. A third element has an upper first opening and a second opening. The third element is secured to opposite ends of the first element. Tubing has one end fluidly communicating with the second opening of the second element and an opposite end fluidly communicates with the second opening of the third element. The third element is higher than the second element so water poured in the third element flows by gravity within the second element. The first element is sufficiently rigid to prevent deformation by the fresh water.

### CROSS REFERENCE TO A RELATED APPLICATION

The present patent application claims the priority of U.S. provisional application Ser. No. 62/673,379, filed May 18, 2018, the content of which is incorporated herein in its entirety.

### TECHNICAL FIELD

The technical field generally relates to a drinking apparatus allowing to provide water to a living entity confined into a restricted environment (e.g. a pet confined into a vehicle). More particularly, the present disclosure relates to a drinking apparatus having opposite ends, one of said opposite ends being insertable through a small opening giving access to the restricted environment, while the other of said opposite ends remains positioned outside the restrain space.

### BACKGROUND

People do not realize that pets can suffer from heat exhaustion and heat strokes like humans can. According to recent studies, if a dog is left within a vehicle during a hot and sunny day, it only takes a few minutes before its life becomes endangered. Even if the windows are completely open, which never happens (otherwise the dog would jump out), the temperature within a parked vehicle rises alarmingly quickly.

Despite this information, dogs are often found locked in cars while their owners go about shopping or eating at restaurants. Most of the time, preferably during summer, people only allow a small opening of one or more windows. Such a small opening is of course not sufficient to prevent a rise of the temperature inside the parked vehicle and the dogs will quickly suffer of dehydration.

While breaking the vehicle's windows can be tolerated if a human infant is left within a vehicle, the same cannot be said for a dog. Perpetrators can be fined for the damages done to the vehicle while the owner of said vehicle will not be penalized for having left their pet under lock, inside the vehicle.

Therefore, there is a strong need for a system or apparatus which would allow a person to provide fresh drinking water to the interior of a restrain space where a pet or other living being, has been left, especially during hot and sunny days, without damaging said vehicle. Preferably, concerning pets, the restrain space may consist of the interior of a vehicle.

### SUMMARY

An embodiment of the invention relates to a drinking apparatus allowing to provide fresh water to a living entity (e.g. a pet) confined into a restricted environment, said drinking apparatus comprising:
(i) a first element having opposite ends;
(ii) a second element defining a capacity provided with a first opening and a second opening, the first opening being provided at an upper part of the second element, the second element being secured to one of the opposite ends of the first element;
(iii) a third element defining a capacity provided with a first opening and a second opening, the first opening being provided at an upper part of the third element, the third element being secured to the other of the opposite ends of the first element; and
(iv) a fourth element defining a tubing having opposite ends, one of the opposite ends of the tubing being in fluid communication with the second opening of the second element, and the other of the opposite ends of the tubing being in fluid communication with the second opening of the third element;
wherein the third element is to be positioned higher than the second element;
wherein when fresh water is poured in the third element, said fresh water being allowed to flow by gravity within the second element via the second opening of the third element, the tubing and the second opening of the second element; and
wherein the first element is sufficiently rigid to prevent being deformed by the weight of the fresh water present in the second element and in the tubing.

Another embodiment of the invention relates to the drinking apparatus defined hereinabove, wherein the one of the opposite ends of the first element is secured to the second element and the other of the opposite ends of the first element is secured to the third element, by any appropriate means. Non-limiting examples of such appropriate means may comprise adhesive material (e.g. glue), mechanical fasteners (e.g. screws, collars, etc.), mortise tenon systems, frictional assemblies, etc.

Another embodiment of the invention relates to the drinking apparatus defined hereinabove, wherein the second element is defining a drinking bowl. Preferably, the drinking bowl may be made of any appropriate material such as metal, plastic, rubber, etc. More preferably, the drinking bowl may be made of a material that can be reversibly deformed while passing through a small opening giving access to the restricted environment, Non limiting examples of a material that can be reversibly deformed may be an elastomeric material and more preferably a rubber-type material such as a natural or a synthetic rubber. Non-limiting examples of plastic material may be polyethylene, PVC or any other similar plastic materials.

Another embodiment of the invention relates to the drinking apparatus defined hereinabove, wherein the third element is defining a pouring bowl, a funnel or a fitting to be connectable to the neck of a bottle. Preferably, the third element may be made of any appropriate material such as metal, plastic, rubber, etc. More preferably, the third element may be made of a plastic material. Non-limiting examples of a plastic material may be polyethylene, PVC or any other similar plastic materials.

Another embodiment of the invention relates to the drinking apparatus defined hereinabove, wherein the fourth element is either a tubing of a material (e.g. a polyethylene tubing, a PVC tubing, etc.), eventually positioned close and preferably parallel to the first element, or alternatively a tubing as defined above housed within said first element or alternatively a tubing making an integral part of the first element.

Another embodiment of the invention relates to the drinking apparatus defined hereinabove, wherein the tubing may consist of at least one plastic tubing having opposite ends, one of said opposite ends being secured to the second element and in fluid communication with the second opening of the second element, and the other of said opposite ends being secured to the third element and in fluid communication with the second opening of the third element.

Another embodiment of the invention relates to the drinking apparatus defined hereinabove, wherein the second opening of the second element is further provided with a tube portion concentric and in fluid communication with the second opening of the second element, and adapted to receive one of the opposite ends of the fourth element. Preferably, the end of the fourth element is engaged and secured in said tube portion by friction of an outer wall of the tubing with a corresponding inner wall of the tube portion, or by any other means such as engagement of threaded surfaces and/or adhesive material.

Another embodiment of the invention relates to the drinking apparatus defined hereinabove, wherein the second opening of the third element is further provided with a tube portion, concentric and in fluid communication with the second opening of the third element, and adapted to receive the other of the opposite ends of the fourth element. Preferably, the other of the opposite ends of the fourth element is engaged and secured in said tube portion by friction of an outer wall of the tubing with a corresponding wall of the tube portion, or by any other means such as engagement of threaded surfaces and/or adhesive material.

Another embodiment of the invention relates to the drinking apparatus defined hereinabove, wherein the fourth element is housed within the first element, and wherein the opposite ends of the first element correspond to the opposite ends of the fourth element to thereby define a piping assembly.

Another embodiment of the invention relates to the drinking apparatus defined hereinabove, wherein the first element and the fourth element are simultaneously defined by a common pipe or a common piping assembly comprising at least two pipes, so the opposite ends of the first element respectively correspond to the opposite ends of the fourth element.

Another embodiment of the invention relates to the drinking apparatus defined hereinabove, wherein the piping assembly comprises a telescopic piping assembly. Preferably, the telescopic piping assembly comprises a tubular rod where a first pipe is telescopically connected to a second pipe.

Another embodiment of the invention relates to the drinking apparatus defined hereinabove, wherein the piping assembly is a pipeline comprising at least two pipes interconnected in series with one or more fittings or connectors.

Another embodiment of the invention relates to the drinking apparatus defined hereinabove, wherein the one or more pipe fittings or connectors may be of any type allowing to connect pipes together, and some of them may be further provided with a bent portion and/or an actuable valve, if desired. They preferably allow connection of pipes by frictional engagement, screwing of threaded surface, gluing, etc.

Another embodiment of the invention relates to the drinking apparatus defined hereinabove, wherein at least one of the one or more fittings or connectors makes an integral part of at least one pipe of the at least two pipes.

Another embodiment of the invention relates to the drinking apparatus defined hereinabove, wherein when the pipe or the piping assembly is canted through an open window of a vehicle (e.g. any angles placing the third element higher that the second element, preferably from 30 to 60° with respect to the horizontal), and preferably according to a further embodiment, a lower portion of the pipe or of the piping assembly may be further provided with a shoulder adapted to position the drinking bowl be substantially horizontal.

Another embodiment of the invention relates to the drinking apparatus defined hereinabove, wherein the bent portion of the lower portion of the pipe or of the piping assembly may be obtained by a combination of fittings or connectors as defined above, or by a mere bending of a section of the pipe or of the piping assembly.

Another embodiment of the invention relates to the drinking apparatus defined hereinabove, wherein when the pipe or the piping assembly is canted through an open window of a vehicle (e.g. any angles placing the third element higher that the second element, preferably from 30 to 60° with respect to the horizontal), and preferably according to a further embodiment, an upper portion of the pipe or of the piping assembly may be further provided with a shoulder adapted to position the third element substantially horizontal.

Another embodiment of the invention relates to the drinking apparatus defined hereinabove, wherein the bent portion of the upper portion of the pipe or of the piping assembly may be obtained by a combination of fittings or connectors as defined above, or by a mere bending of a section of the pipe or of the piping assembly.

Another embodiment of the invention relates to a method for providing fresh water to a living entity (e.g. a pet) confined into a restricted environment via a small opening with the drinking apparatus defined hereinabove, said method comprising the steps of
a) inserting the second element and a portion of the first element through the small opening to reach the restricted environment;
b) pouring an amount of fresh water in the third element to allow said fresh water to flow by gravity within the second element via the second opening of the third element, the tubing and the second opening of the second element, to fill said third element and allow the living entity to drink water therefrom.

Another embodiment of the invention relates to a use of the drinking apparatus defined hereinabove to provide fresh water to a living entity (e.g. a pet) confined into a restricted environment.

### BRIEF DESCRIPTION OF THE DRAWINGS

FIG. 1 is a perspective view of a drinking apparatus according to an embodiment, showing a pair of bowls connected at either ends of a tubular rod.

FIG. 2 is an enlarged sectional view of an end of the drinking apparatus, showing a drinking bowl connected to the tubular rod, according to an embodiment.

FIG. 3 is a perspective view of the drinking apparatus of FIG. 1, showing the drinking apparatus in an extended configuration, according to an embodiment;

FIG. 4 is a perspective view of the drinking apparatus of FIG. 1 positioned across a small opening provided in the window of a car;

FIG. 5 is a view of perspective view of to another embodiment of a drinking apparatus according to the invention; and

FIG. 6 is a perspective view of the drinking apparatus of FIG. 5 according to line VI-VI.

### DETAILED DESCRIPTION

Various embodiments are described in the following disclosure with reference to the accompanying figures. It should be understood that the elements of these figures are not necessarily depicted to scale, since emphasis is placed upon clearly illustrating the elements and structures of the present embodiments. In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

As will be explained below in relation to various embodiments, a drinking apparatus is provided. Broadly described, the apparatus allows to provide water in a drinking bowl within an environment with restricted or limited access for example. It will become apparent upon reading this disclosure that the drinking transfer apparatus can be used with any other suitable environment. According to a preferred embodiment, the drinking apparatus may include, among other components, a drinking bowl made of a flexible material adapted to be inserted within the restricted environment.

Moreover, it will be appreciated that positional descriptions such as “longitudinal”, “transversal”, “left”, “right”, “upper”, “lower”, “external”, “internal”, “outer”, “inner”, “oblique”, “parallel”, “perpendicular” and the like should be taken in the context of the figures only and should not be considered limiting.

In addition, although the optional configurations as illustrated in the accompanying drawings comprises various components and although the optional configurations of the apparatus as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations therein between, as well as other suitable geometrical configurations may be used for the drinking apparatus, and corresponding parts, as briefly explained and as can be easily inferred here from, without departing from the scope of the disclosure.

In some embodiments, the drinking apparatus can be particularly useful in providing water to a pet, or any other animal, that has been left within a vehicle, especially on a hot and sunny day. Furthermore, the various embodiments of the apparatus described herein can be adapted and/or configured for rescue operations, being part of a kit comprising a plurality of devices, for example. It is appreciated that aspects and/or advantages described in conjunction with a particular embodiment are not necessarily limited to that singular embodiment and can be practiced/achieved in any other embodiments even if not so illustrated and/or described.

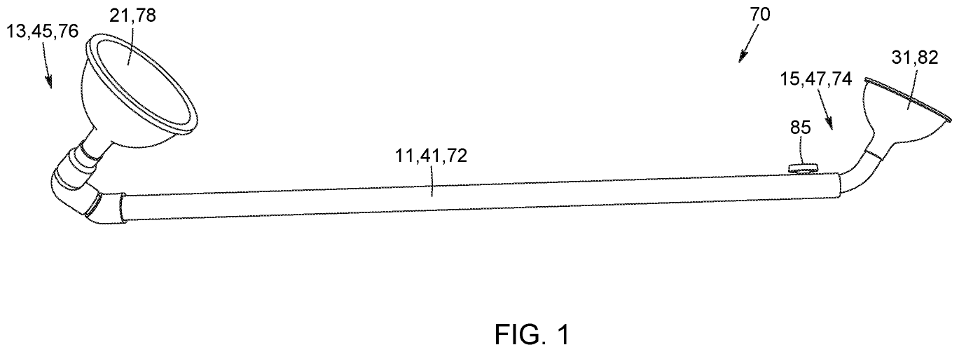

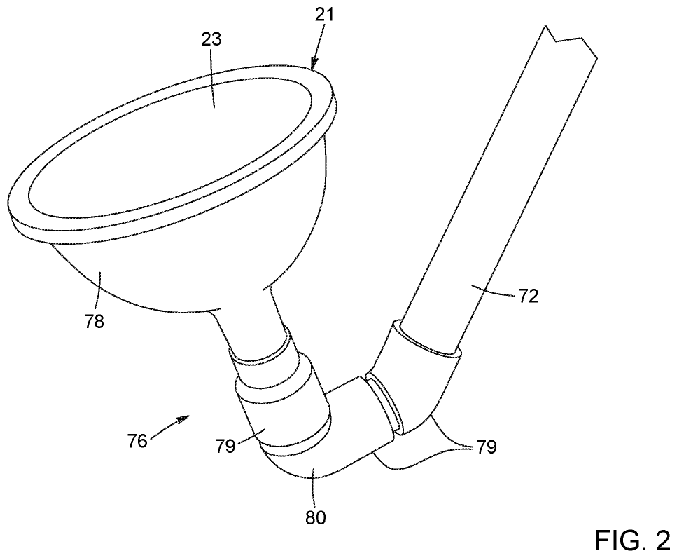

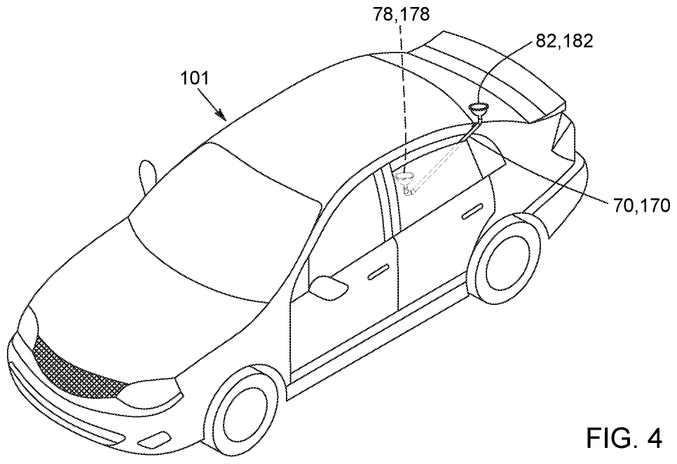

With reference to FIGS. 1 to 4, the drinking apparatus 70 can be adapted to allow a user, located outside a vehicle (or any other type of restricted capacity), to provide the inhabitants of said vehicle with water. For example, the drinking apparatus 70 can be inserted through an open window (see FIG. 4) to allow water to be provided to a pet that has been locked inside of a vehicle 101.

More particularly, with reference to FIGS. 1 to 3, the drinking apparatus 70 is comprising:
(i) a first element 11 having opposite ends 13 and 15;
(ii) a second element 21 defining a capacity 23 provided with a first opening and a second opening, the first opening being provided at an upper part of the second element 21, the second element 21 being secured to the end 13 of the first element 11;
(iii) a third element 31 defining a capacity 33 provided with a first opening and a second opening, the first opening being provided at an upper part of the third element 31, the third element 31 being secured to the end 15 of the first element 11; and
(iv) a fourth element 41 defining a tubing having opposite ends 45 and 47, the end 45 of the tubing being in fluid communication with the second opening of the second element 21, and the end 47 of the tubing being in fluid communication with the second opening of the third element 31;
wherein the third element 31 is to be positioned higher than the second element 21;
wherein when fresh water is poured in the third element 31, said fresh water being allowed to flow by gravity within the second element 21 via the second opening of the third element 31, the tubing and the second opening of the second element 21; and
wherein the first element 11 is sufficiently rigid to prevent being deformed by the weight of the fresh water present in the second element 21 and in the tubing.

The first element 11 can be made of any appropriate material that is sufficiently rigid to prevent being deformed by the weight of the fresh water present in the second element 21 and in the tubing of the fourth element 41. This first element 11 may be made of metal (e.g. aluminum or any other metal or alloy) or plastic (e.g. polyethylene, PVC or any other polymeric material), Preferably, according to the preferred embodiment illustrated in FIGS. 1 to 3, the first element 11 is made of PVC.

The second element 21 may be defining, a drinking bowl 78 made of any suitable material such as metal, plastic, rubber, etc. This second element 21 can be secured to the end 13 of the first element by any appropriate means such as gluing, mechanical fasteners, mortice tenon systems, frictional engagement, screwing of threaded surfaces, etc. Preferably, according to the preferred embodiment illustrated in FIGS. 1 to 3, the drinking bowl 78 is made of silicone rubber.

The third element 31 may be defining a pouring bowl 82. This pouring bowl 82 may be made of any appropriate material such as metal, plastic, rubber, etc. Also, this pouring bowl can be secured to the end 13 of the first element by any appropriate means such as gluing, mechanical fasteners, mortice tenon systems, frictional engagement, screwing of threaded surfaces, etc. Alternatively, the pouring bowl 82 can be replaced by a funnel or a fitting connectable to a water supply (e.g. connectable to the neck of a bottle of water). Preferably, according to the preferred embodiment illustrated in FIGS. 1 to 3, the pouring bowl 82 is made of silicone rubber.

The fourth element 41 may be a piping assembly, preferably a telescopic piping assembly 73 having its end 45 connected to the second opening of the second element 21 by any appropriate fitting or connectors 79. Optionally, the end 47 may be connected to the second opening 37 of the third element 31 by any appropriate fitting or connectors.

According to one particularly preferred embodiment, illustrated in FIGS. 1 to 3, the first element 11 and the fourth element 41 are defined by a common same a piping assembly 72 having a first end 74 opposite a second end 76.

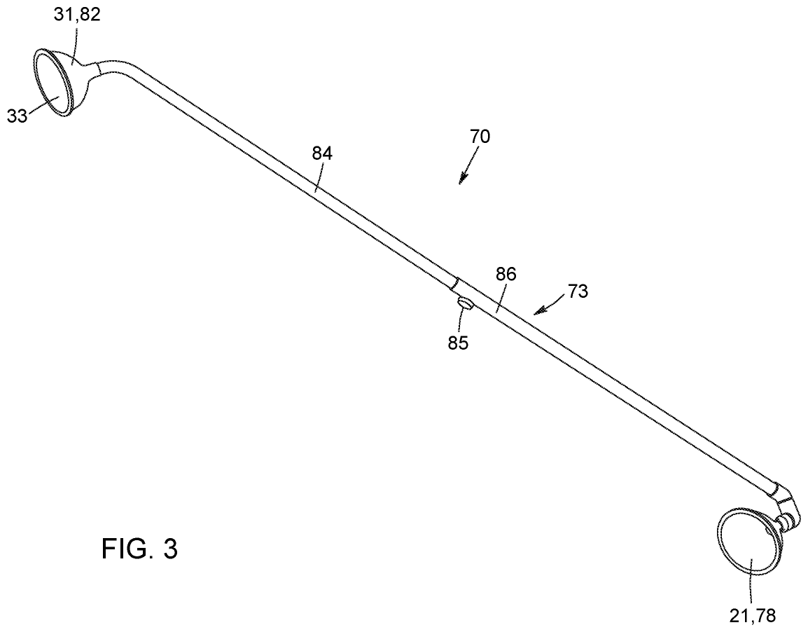

More particularly, the piping assembly 72 is the telescopic piping assembly 73 comprising a first pipe 84 telescopically connected to a second pipe 86. The telescopic piping assembly 73 can therefore be lengthened to facilitate reaching the animal within the vehicle with the drinking bowl 78. A non-limiting example of the telescopic piping assembly 73 in a lengthened configuration is shown in FIG. 3. In the present embodiment illustrated in FIGS. 1 to 3, the telescopic piping assembly 73 is hollow, therefore allowing water to flow from the first end 74 to the second end 76.

In some embodiments, the second end 76 is provided with a drinking bowl 78, which can be filled by pouring water within the first end 74.

A person skilled in the art will readily understand that the first end 74 needs to be vertically higher than the second end 76 while pouring water to allow the drinking bowl 78 to fill. Furthermore, as mentioned above, it is appreciated that the drinking bowl 78 can be made of material adapted to facilitate insertion within a restricted opening, such as an open window of a vehicle.

In order for the pet to easily drink from the drinking bowl 78, the second end 76 can be provided with a shoulder 80 adapted to have the drinking bowl 78 be substantially horizontal, while the piping assembly 72 is canted through the open window of the vehicle. As illustrated in FIGS. 1 to 3, the shoulder 80 is obtained by connecting appropriate fittings or connectors 79.

Moreover, to facilitate pouring water within the first end 74, the drinking apparatus can be provided with a pouring bowl 82 located at the first end 74. Therefore, water can be poured within the pouring bowl 82 to fill the drinking bowl 78 located at the opposite end of the piping assembly 72. Alternatively, the pouring bowl 82 can be replaced by a funnel or a fitting connectable to a water supply (e.g. connectable to the neck of a bottle of water).

In this embodiment, the piping assembly 72 is a telescopic piping assembly 73, and comprises a first pipe 84 telescopically connected to a second pipe 86. The telescopic piping assembly 73 can therefore be lengthened to facilitate reaching the animal within the vehicle with the drinking bowl 78. A non-limiting example of the telescopic piping assembly 73 in a lengthened configuration is shown in FIG. 3.

With reference to FIGS. 4, 5 and 6, the drinking apparatus 170 can be adapted to allow a user, located outside a vehicle (or any other type of restricted capacity), to provide the inhabitants of said vehicle with water. For example, the drinking apparatus 170 can be inserted through an open window (see FIG. 4) to allow water to be provided to a pet that has been locked inside of a vehicle 101.

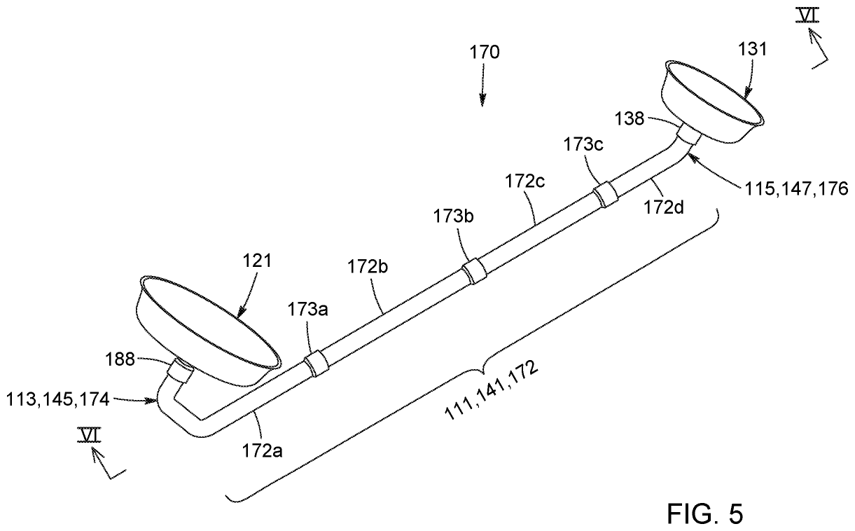

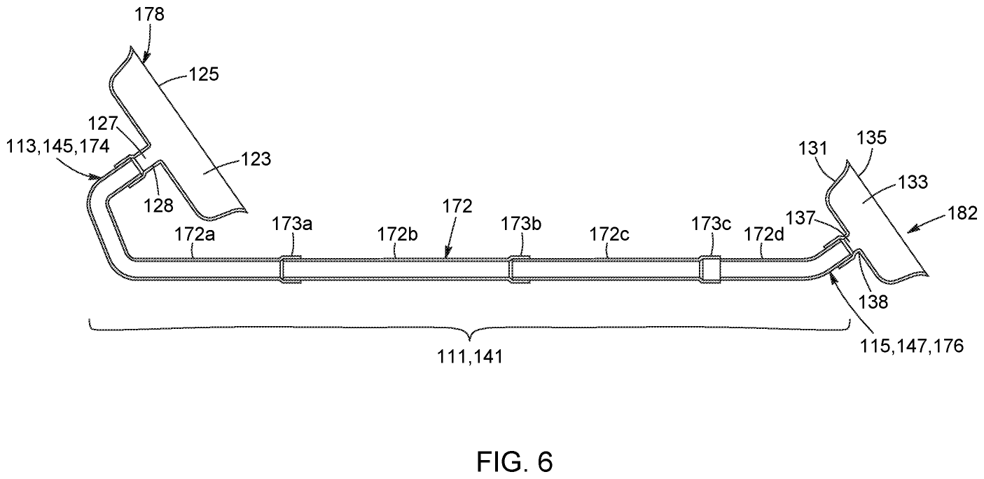

More particularly, with reference to FIGS. 5 and 6, the drinking apparatus 170 is comprising:
a first element 111 having opposite ends 113 and 115;
a second element 121 defining a capacity 123 provided with a first opening 125 and a second opening 127, the first opening 125 being provided at an upper part of the second element 121, the second element 121 being secured to the end 113 of the first element 111;
a third element 131 defining a capacity 133 provided with a first opening 135 and a second opening 137, the first opening 135 being provided at an upper part of the third element 131, the third element 131 being secured to the end 115 of the first element 111; and
a fourth element 141 defining a tubing having opposite ends 145 and 147, the end 145 of the tubing being in fluid communication with the second opening 127 of the second element 121, and the end 147 of the tubing being in fluid communication with the second opening 137 of the third element 131;
wherein the third element 131 is to be positioned higher than the second element 121;
wherein when fresh water is poured in the third element 131, said fresh water being allowed to flow by gravity within the second element 121 via the second opening 137 of the third element 131, the tubing and the second opening 127 of the second element 121; and
wherein the first element 111 is sufficiently rigid to prevent being deformed by the weight of the fresh water present in the second element 121 and in the tubing.

According to one particularly preferred embodiment, illustrated in FIGS. 5 and 6, the first element 111 and the fourth element 141 are defined by a common a piping assembly or pipeline 172 having a first end 174 opposite a second end 176. More particularly, the piping assembly 172 is a pipeline of pipes 172a, 172b, 172c and 172d.

According to the embodiment illustrated in FIGS. 5 and 6, the second element 121 is a drinking bowl 178 defines a capacity 123 and is made of silicone rubber. This drinking bowl 178 has a first opening a first opening 125 and a second opening 127. The first opening 125 is provided at an upper part of the second element 121. The second opening 127 comprises a tube portion 128;

According to the embodiment illustrated in FIGS. 5 and 6, the third element 131 may be defining a pouring bowl 182. This pouring bowl 182 may be made of silicone rubber. This pouring bowl 182 defines a capacity 133 and is made of silicone rubber. This pouring bowl 182 has a first opening 135 and a second opening 137. The first opening 135 is provided at an upper part of the second element 121. The second opening 137 comprises a tube portion 138;

The pipe 172a has opposite ends. One of said opposite end is inserted in the tube portion 128 of the drinking bowl 178 and secured in place by frictional engagement of the tube portion 128 on a corresponding outer surface of the pipe 172a to allow a fluid communication of the pipe 172a with the capacity 123 of the drinking bowl 178. The other of said opposite ends is provided with a fitting element 173a.

The pipe 172b has opposite ends. One of said opposite end is inserted in the fitting element 173a and secured in place by frictional engagement of the fitting element 173a on a corresponding outer surface of the pipe 172b to allow a fluid communication between pipes 172a and 172b. The other of said opposite ends of pipe 172b is provided with a fitting element 173b.

The pipe 172c has opposite ends. One of said opposite end is inserted in the fitting element 173b and secured in place by frictional engagement of the fitting element 173b on a corresponding outer surface of the pipe 172c to allow a fluid communication between pipes 172b and 172c. The other of said opposite ends of pipe 172c is provided with a fitting element 173c.

The pipe 172d has opposite ends. One of said opposite end is inserted in the fitting element 173c and secured in place by frictional engagement of the fitting element 173c on a corresponding outer surface of the pipe 172d to allow a fluid communication between pipes 172c and 172d. The other of said opposite ends of pipe 172d is inserted in the tube portion 138 of the pouring bowl 182 and secured in place by frictional engagement of the tube portion 138 on a corresponding outer surface of the pipe 172d.

In some embodiments, the second end 176 is provided with a drinking bowl 178, which can be filled by pouring water within the first end 174.

A person skilled in the art will readily understand that the first end 174 needs to be vertically higher than the second end 176 while pouring water to allow the drinking bowl 178 to fill. Furthermore, as mentioned above, it is appreciated that the drinking bowl 178 can be made of material adapted to facilitate insertion within a restricted opening, such as an open window of a vehicle.

In order for the pet to easily drink from the drinking bowl 178, a portion of the pipe 172a is bent to have the drinking bowl 178 be substantially horizontal, while the piping assembly 172 is canted through the open window of the vehicle.

Moreover, to facilitate pouring water within the first end 174, the water can be poured within the pouring bowl 182 to fill the drinking bowl 178 located at the opposite end of the piping assembly 172. Preferably, as illustrated, the pipe 172d is bent to have the pouring bowl substantially horizontal, while the piping assembly 172 is canted through the open window of the vehicle.

According to a preferred embodiment, pipes 172a, 172b, 172c and 172d can be removably connected or disconnected, to limit the volume of the drinking apparatus for storage purposes. Also, drinking bowl 178 and pouring bowl 182 can be removably connected or disconnected from corresponding pipe 172a and 172d.

1. A drinking apparatus for providing fresh water to a living entity confined into a restricted environment, said drinking apparatus comprising:
(i) a first element having opposite ends;
(ii) a second element defining a capacity provided with a first opening and a second opening, the first opening being provided at an upper part of the second element, the second element being secured to one of the opposite ends of the first element;
(iii) a third element defining a capacity provided with a first opening and a second opening, the first opening being provided at an upper part of the third element, the third element being secured to the other of the opposite ends of the first element; and
(iv) a fourth element defining tubing having opposite ends, one of the opposite ends of the tubing being in fluid communication with the second opening of the second element, and the other of the opposite ends of the tubing being in fluid communication with the second opening of the third element;
wherein the third element is positioned higher than the second element;
wherein when fresh water is poured in the third element, said fresh water is allowed to flow by gravity within the second element via the second opening of the third element, the tubing and the second opening of the second element; and
wherein the first element is sufficiently rigid to prevent being deformed by weight of the fresh water present in the second element and in the tubing.

2. The drinking apparatus according to claim 1, wherein the second element defines a drinking bowl made of a material that is reversibly deformable while passing through an opening giving access to the restricted environment.

3. The drinking apparatus according to claim 1, wherein the third element defines a pouring bowl, a funnel or a fitting connectable to the neck of a bottle.

4. The drinking apparatus according to claim 1, wherein the fourth element is housed within the first element, and wherein the opposite ends of the first element correspond to the opposite ends of the fourth element to define a piping assembly.

5. The drinking apparatus according to claim 4, wherein the piping assembly comprises a telescopic piping assembly.

6. The drinking apparatus according to claim 4, wherein the piping assembly is a pipeline made of at least two pipes interconnected in series.

7. The drinking apparatus according to claim 6, wherein the at least two pipes are interconnected with one or more fittings.

8. The drinking apparatus according to claim 4, wherein when the piping assembly is canted through an open window of a vehicle, a lower portion of the piping assembly is further provided with a shoulder adapted to position the drinking bowl to be substantially horizontal.

9. The drinking apparatus according to claim 1, wherein the second element defines a drinking bowl made of a material that is reversibly deformable while passing through an opening giving access to the restricted environment; wherein the third element defines a pouring bowl, a funnel or a fitting connectable to the neck of a bottle, wherein the fourth element is housed within the first element, and wherein the opposite ends of the first element correspond to the opposite ends of the fourth element to define a piping assembly.

10. The drinking apparatus according to claim 9, wherein the piping assembly is a pipeline made of at least two pipes interconnected in series.

11. The drinking apparatus according to claim 10, wherein the at least two pipes are interconnected with one or more fittings.

12. The drinking apparatus according to claim 9, wherein when the piping assembly is canted through an open window of a vehicle, a lower portion of the piping assembly is further provided with a shoulder adapted to position the drinking bowl to be substantially horizontal.

13. A method for providing fresh water to a living entity confined into a restricted environment via an opening with the drinking apparatus defined in claim 1, said method comprising the steps of:
a) inserting the second element and a portion of the first element through the opening to reach the restricted environment;
b) pouring an amount of fresh water in the third element to allow said fresh water to flow by gravity within the second element via the second opening of the third element, the tubing and the second opening of the second element, to fill said third element and allow the pet to drink water therefrom.

14. A method for providing fresh water to a living entity confined into a restricted environment via a small opening with the drinking apparatus defined in claim 9, said method comprising the steps of
a) inserting the second element and a portion of the first element through the small opening to reach the restricted environment;
b) pouring an amount of fresh water in the third element to allow said fresh water to flow by gravity within the second element via the second opening of the third element, the tubing and the second opening of the second element, to fill said third element and allow the living entity to drink water from the third element.
